(19) United States
(12) Patent Application Publication
(10) Pub. No.: US 2017/0255029 A1
(43) Pub. Date: Sep. 7, 2017

(54) SYSTEMS AND METHODS FOR CHARGING EYEWEAR

(71) Applicant: Vision Service Plan, Rancho Cordova, CA (US)

(72) Inventors: Richard Chester Klosinski, JR., Sacramento, CA (US); Matthew Allen Workman, Sacramento, CA (US); Adam Oranchak, Takoma Park, MD (US); Jeff Park, Long Island, NY (US); Kristina Gaudio, Ocean, NJ (US)

(21) Appl. No.: 15/060,333

(22) Filed: Mar. 3, 2016

(51) Int. Cl. G02C 11/00; G02C 5/22; H02J 7/00; G02C 5/14

(52) U.S. Cl. CPC G02C 11/10; G02C 5/146; G02C 5/22; H02J 7/0045

(57) ABSTRACT

A computerized eyewear retrofit kit for use with an eyewear frame comprises an elongated body having a first end comprising a first end surface and a connector that is configured to pivotally couple to an eyewear frame, and a second end configured to rest on an ear of a wearer wearing the eyewear frame. At least one processor is mounted in the elongated body and is coupled to a rechargeable power source mounted in the elongated body. At least one sensor is coupled to the elongated body and operatively coupled to the at least one processor. A charging port is formed in the elongated body first end surface that is configured to receive a charging cable, wherein when the computerized temple is coupled to an eyewear frame using the connector and the elongated body is substantially perpendicular to a rear surface of the eyewear frame, the charging port is hidden.

### BACKGROUND

It has become increasingly important to monitor the health and activities of individuals. Accordingly, there is a need for improved devices that make monitoring these aspects of an individual easier and more convenient to use. Additionally, since such devices may comprise one or more computer processors and/or sensors, may require power to operate, and may be powered by one or more rechargeable batteries, there is also a need for improved systems and methods for charging such devices. For example, there is a need for convenient and discrete ways to charge such devices. Various embodiments of the present charging systems and methods recognize and address the foregoing considerations, and others, of prior art devices.

### SUMMARY

Computerized eyewear, according to various embodiments, comprises (1) a frame having a first end, a second end, a top surface, a front surface and a rear surface; (2) a first temple comprising (i) a first end having a surface, wherein the first temple first end is pivotally coupled to the frame first end, and (ii) a second end configured to rest on an ear of the wearer of the computerized eyewear; (3) a second temple comprising (i) a first end that is pivotally coupled to the frame second end, and (ii) a second end configured to rest on another ear of the wearer of the computerized eyewear; (4) at least one processor coupled to one of the first temple or the frame; (5) a power source coupled to one of the first temple or the frame, wherein the at least one processor is operatively coupled to the power source; and (6) a charging socket positioned in the first temple, first end surface, wherein the charging socket is operatively coupled to the power source, wherein the charging socket is hidden from view when the first temple is positioned substantially perpendicular to the frame's rear surface.

In various embodiments, the charging socket is a micro universal serial bus female socket. In particular embodiments, the charging socket comprises a magnetic material that is configured to retain a charging connector in the charging socket. In some embodiments, the magnetic material is a paramagnetic material that possesses magnetization in the presence of a magnetic field. In various embodiments, when the temple is positioned substantially parallel to the frame rear surface, the charging socket is accessible to allow the wearer to insert a charging cable into the charging socket. In various embodiments, the computerized eyewear further comprises a charging cable that comprises a magnetic tip.

Computerized eyewear according to certain embodiments comprises: (1) a frame having a first side, a second side, an upper surface and a lower surface; (2) at least one temple comprising a first end configured to be coupled to the first side of the frame, a second end configured to rest on an ear of a wearer, and a longitudinal axis that extends from the first end to the second end; (3) a processor coupled to at least one of the frame and the at least one temple; (4) a rechargeable power source coupled to at least one of the frame and the at least one temple and operatively coupled to the processor; and (5) a charging port positioned on the first end of the at least one temple, where the charging port is configured to releasably receive a charging cable connector so that the rechargeable power source can be recharged when the charging cable is connected to the charging port.

In various embodiments, the at least one temple first end is pivotally coupled to the frame first side so that when the at least one temple longitudinal axis is positioned perpendicular to a plane that extends between the frame first side and the frame second side, the charging port is hidden from view. In various embodiments, the charging port is a socket selected from a group consisting of (i) a micro universal serial bus female socket, (2) a mini universal serial bus female socket, and (3) a Lightning® female socket. In some embodiments, the charging port further comprises a magnetic material that retains the charging cable in the charging port. In some of these embodiments, the magnetic material comprises and/or consists of a plate that is mounted in the charging port. In some embodiments, the magnetic material is a paramagnetic material.

In certain embodiments, a computerized eyewear retrofit kit for use with an eyewear frame comprises: (1) an elongated body having (i) a first end comprising a first end surface and a connector that is configured to pivotally couple to an eyewear frame, and (ii) a second end configured to rest on an ear of a wearer wearing the eyewear frame; (2) at least one processor mounted in the elongated body; (3) a rechargeable power source mounted in the elongated body and operatively coupled to the at least one power source; (4) at least one sensor coupled to the elongated body and operatively coupled to the at least one processor; and (5) a charging port formed in the elongated body first end surface that is configured to receive a charging cable, wherein when the computerized temple is coupled to an eyewear frame using the connector and (a) the elongated body is substantially perpendicular to a rear surface of the eyewear frame, the charging port is hidden, and (b) the elongated body is substantially parallel to the rear surface of the eyewear frame, the charging port is accessible so that the wearer can connect the charging cable to the charging port to recharge the rechargeable power source.

### BRIEF DESCRIPTION OF THE DRAWINGS

Various embodiments of a computerized replacement temple for assessing a user's health and activities are described below. In the course of this description, reference will be made to the accompanying drawings, which are not necessarily drawn to scale and wherein:

FIG. 1 is a front perspective view of an embodiment of a computerized replacement temple attached to standard eyewear;

FIG. 2 is a front perspective view of the computerized replacement temple unattached to the standard eyewear;

FIGS. 3A-3B are partial perspective views of the eyewear of FIG. 1 illustrating how to connect the charging cord to the computerized temple according to various embodiments;

FIGS. 4A-4B are partial sectional views of the eyewear of FIG. 1 and the charging cable;

FIGS. 5A-5C are front perspective views of the eyewear of FIG. 1 showing how to charge the computerized eyewear, according to embodiments; and

FIG. 6 depicts exemplary system architecture for an example computing device for use in the computerized temple of FIG. 1.

### DETAILED DESCRIPTION

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Eyewear

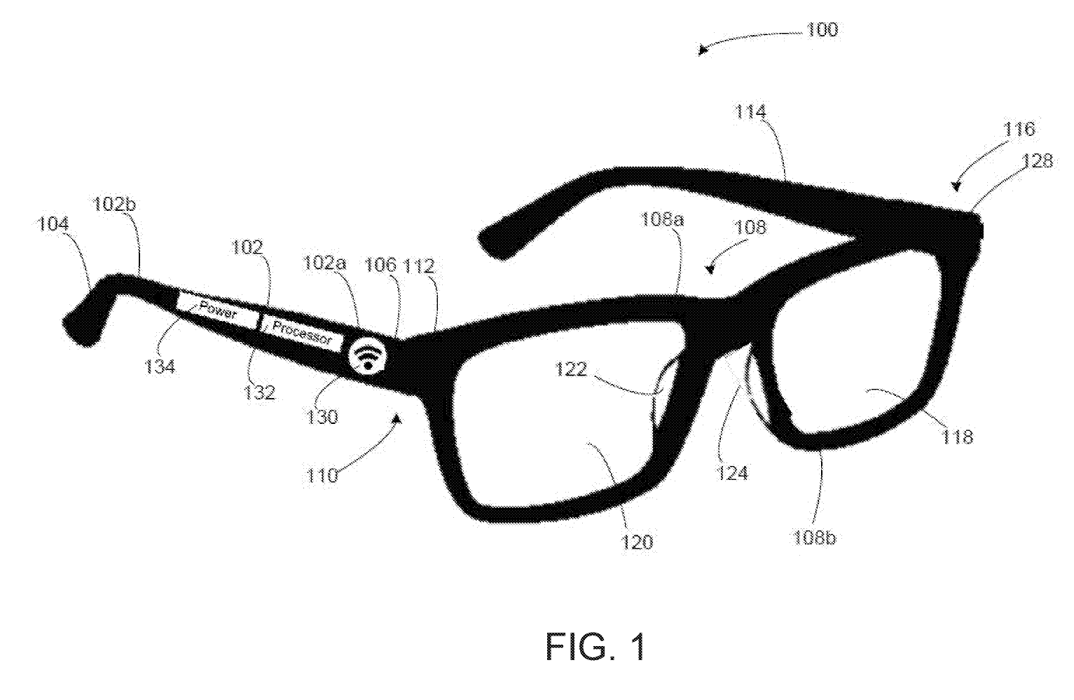

As shown in FIG. 1, eyewear 100, according to various embodiments, is a standard pair of eyewear (e.g., any suitable pair of eyewear with a frame and one or more temples) that has had one of its temples replaced with a computerized temple 102 (e.g., the standard pair of eyewear has been retrofitted to include a computerized temple 102). In particular embodiments, the eyewear 100 includes: (1) an eyewear frame 108; (2) a computerized temple 102 with one or more sensors 130 that is attached (e.g., pivotably attached) to a first lateral side of the eyewear frame; and (3) a second temple 114 that is attached (e.g., pivotably attached) to a second lateral side of the eyewear frame. These various components are discussed in more detail below.

Eyewear Frame

Referring still to FIG. 1, eyewear 100, in various embodiments, includes any suitable eyewear frame 108 configured to support one or more lenses 118, 120. In the embodiment shown in this figure, the eyewear frame 108 has a first end 110 and a second end 116. The eyewear frame 108 also has a top surface 108a (e.g., brow bar and bridge), and a bottom surface 108b (e.g., the bottom surface of the frame's first and second lens rims). The eyewear frame 108 may be made of any suitable material such as one or more metals, metal alloys, ceramics, polymers, etc. or any combination thereof In particular embodiments, the eyewear frame 108 is configured to support the first and second lenses 118, 120 about the full perimeter of the lenses. In other embodiments, the eyewear frame 108 may be configured to support the first and second lenses 118, 120 about only a portion of each respective lens (e.g., a semi-rimless or rimless frame). In various embodiments, the eyewear frame 108 is configured to support a number of lenses other than two lenses (e.g., a single lens, a plurality of lenses, etc.). In particular embodiments, the lenses 118, 120 may include prescription lenses, sunglass lenses, or any other suitable type of lens (e.g., reading lenses, non-prescription lenses), which may be formed, for example, from glass or a suitable polymer.

The eyewear frame 108 includes a first nose pad 122 and a second nose pad 124, which may be configured to maintain the eyewear 100 adjacent the front of a wearer's face such that the lenses 118, 120 are positioned substantially in front of the wearer's eyes while the wearer is wearing the eyewear 100. In particular embodiments, the nose pads 122, 124 may comprise a material that is configured to be comfortable when worn by the wearer (e.g., rubber, polymer, etc.). In other embodiments, the nose pads 122, 124 may include any other suitable material (e.g., plastic, metal, etc.). In still other embodiments, the nose pads 122, 124 may be integrally formed with the frame 108 and made from the same material as the eyewear frame 108.

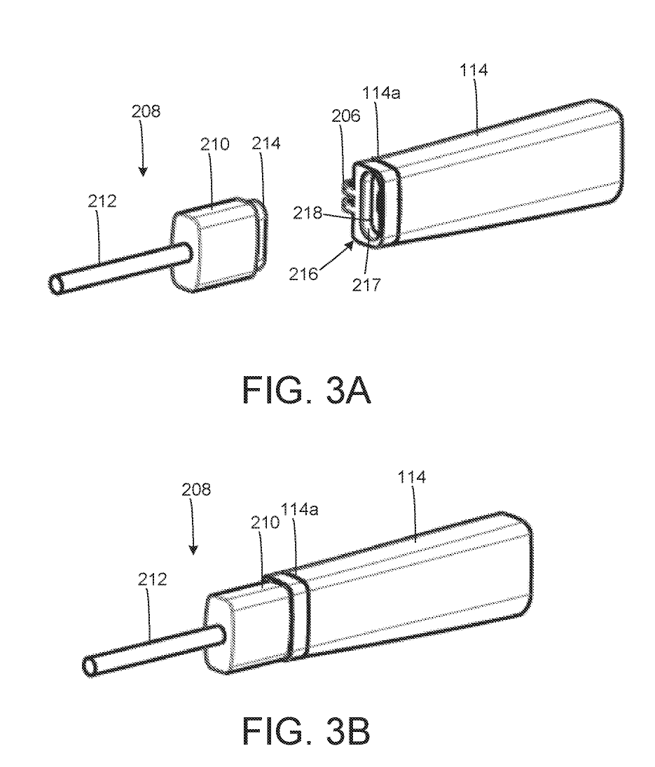

The eyewear frame 108 includes a first connection receiving end 112 that attaches the computerized temple 102 to the frame first end 110, and a second connection receiving end 128 that attaches the second temple 114 to the frame second end 116. In various embodiments, the connection receiving ends 112, 128 may be releasably coupled to the computerized temple 102 and the second temple 114, respectively, by any suitable connection (e.g., tongue and groove, ball and socket, spring hinge, friction fit, screw, spring loaded ball and catch, spring loaded pin and catch, spring tab and catch, hinge and screw, etc.). In particular embodiments, the first and second connection receiving ends 112, 128 may be welded to, or integrally formed with, the eyewear frame 108. In some embodiments, the computerized temple 102 is pivotally coupled to the frame first end 110 by a hinge as described in more detail in FIGS. 3A-3B.

Computerized Temple

As shown in FIG. 1, the computerized temple 102 has an elongated body that includes a first end 102a and a second end 102b. In various embodiments, the first end 102a has a coupling that is configured to retrofit to at least a portion of a hinge of a standard pair of eyewear. In particular embodiments, the second end 102b defines an earpiece 104 proximate the second end 102b that is configured to support the temple on a wearer's ear. A temple hinge connection 106 is proximate the first end 102a. The computerized temple 102 also has a top surface, a bottom surface, an outer (front) surface, and an inner (back) surface (surfaces not numbered).

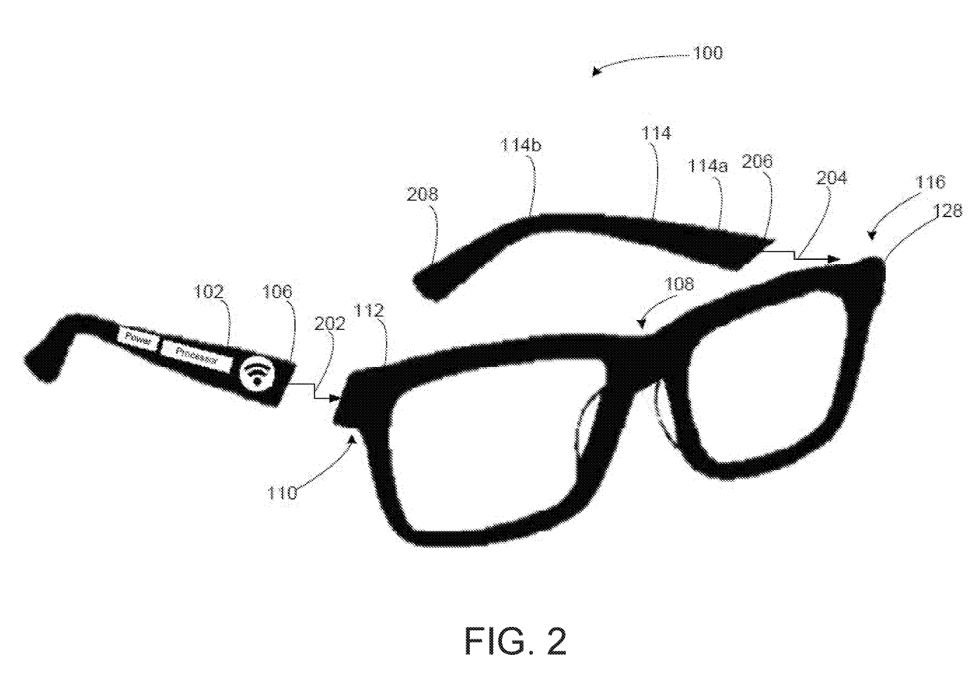

Referring to FIG. 2, the temple hinge connection 106 is adapted to be releasably coupled to the eyewear frame first connection receiving end 112 by any suitable hinge connection 202 (e.g., ball and socket hinge connection, friction fit hinge, screw hinge, spring loaded ball and catch hinge, spring loaded pin and catch hinge, or spring tab and catch hinge). In various embodiments, the eyewear frame first connection receiving end 112 may contain a first portion of a hinge and the computerized temple hinge connection 106 may contain a second portion of the hinge, where the first and second portions of the hinge form a pivotable hinge. Thus, the computerized temple 102 is releasably coupled to the eyewear frame 108 at the eyewear frame first end 110 by the coupling of the first hinge connection receiving end 112 to the temple hinge connection 106 at the hinge connection 202. For each of the different hinge connections, the first hinge connection receiving end 112 and the temple hinge connection 106 are formed by complimentary hinge connections 202. For instance, where the first hinge connection receiving end 112 includes a ball, the temple hinge connection 106 may include a socket. As a further example, where the first hinge connection receiving end 112 includes a screw hinge, the temple hinge connection 106 may also include a screw hinge. In various embodiments, the hinge connection 202 further comprises a cavity (not shown) that opens to at least the computerized temple first end 102. In particular embodiments, the cavity is configured to receive at least a portion of the hinge connection receiving end 112 and the computerized temple 102 is thereby releasably secured to at least a portion of the hinge connection receiving end 112 by a press-fit.

Referring again to FIG. 1, the computerized temple 102 includes one or more sensors 130, at least one processor 132, and a power source 134 coupled (e.g., embedded in, coupled to, operatively coupled to, etc.) to the computerized temple 102. In particular embodiments, the at least one processor 132 is operatively coupled to the one or more sensors 130. In other embodiments, the power source 134 is operatively coupled to the at least one processor 132 and the one or more sensors 130. In various embodiments, each of the one or more sensors 130, the at least one processor 132, and the power source 134 may be coupled to the temple. In still other embodiments, the one or more sensors may be coupled to one or more portions of the frame 108, the computerized temple 102, the second temple 114, the first and second lenses 118, 120, or any other portion (e.g., the nose pads 122, 124, the rim 108b, etc.) of the eyewear 100 in any suitable way.

As a further example, the at least one processor 132 and the power source 134 may be embedded into the computerized temple 102. In some such embodiments, at least one of the one or more sensors 130 may be embedded or coupled to the computerized temple 102, another of the one or more sensors 130 may be coupled to the frame 108, and still another of the one or more sensors 130 may be operatively coupled to the nose piece 122 (FIG. 1). In various embodiments, the one or more sensors 130, the at least one processor 132, and the power source 134 may be coupled at any point along the eyewear 100 and/or the computerized temple 102. For instance, a temperature sensor may be disposed adjacent the outer (front) surface of the computerized temple 102.

In particular embodiments, the computerized temple 102 may further include one or more user interfaces for communicating with a wearer of the computerized temple 102. For example, the computerized temple 102 may include one or more speakers, microphones, displays, and/or other user interface devices that are operatively coupled to facilitate the transfer of information between the wearer of the temple and the temple's one or more processors (e.g., while the wearer is wearing the temple). The computerized temple 102 may further include one or more wireless communications devices (e.g., a Bluetooth chip, a near field communications chip, or a cellular communications chip) for facilitating communication between the computerized temple 102 and one or more remote computing devices (e.g., a central server or the wearer's handheld computing device, laptop computer, etc.).

In various embodiments, the one or more sensors 130, the at least one processor 132, and the power source 134 may be formed in any shape. In particular embodiments, the one or more sensors 130, the at least one processor 132, and the power source 134 may be formed on the inner (back) surface of the frame 108, the computerized temple 102, the second temple 114, the first and second lenses 118, 120, or any other portion of the eyewear 100. In other embodiments, the one or more sensors 130 may be formed on the outer (front) surface of the frame 108, the computerized temple 102, the second temple 114, the first and second lenses 118, 120, or any other portion of the eyewear 100.

Sensors

Still referring to FIG. 1, the computerized temple 102, according to various embodiments, includes one or more sensors 130 that are operatively coupled to the at least one processor 132. In particular embodiments, the one or more sensors 130 are configured to determine one or more current physical attributes of the wearer (e.g., heart rate, brain wave activity, movement, body temperature, blood pressure, oxygen saturation level, etc.). In various embodiments, the one or more sensors 130 are configured to detect one or more physiological characteristics associated with the wearer of the computerized temple 102. In some embodiments, the physiological characteristics may include, for example: (1) the wearer's heart rate; (2) the wearer's respiratory rate; (3) the wearer's brainwave activity; (4) a gait pattern of the wearer; (5) a head position of the wearer; (6) a speed of the wearer; and (7) a movement pattern of the wearer. In still other embodiments, the one or more sensors 130 are configured to detect one or more characteristics of the environment surrounding the wearer of the computerized temple 102. In various embodiments, the characteristic of the environment may include, for example: (1) the wearer's location; (2) a medicine that the wearer is preparing to take; (3) a food that the wearer is preparing to eat; (4) an amount of ultraviolet light that the wearer is subjected to; (5) a smell of an item in close proximity to the wearer; (6) a proximity of the wearer to an object; and (7) an identity of an object associated with the wearer.

The one or more sensors 130 may include, for example: (1) one or more heart rate monitors; (2) one or more electrocardiograms (EKG); (3) one or more electroencephalograms (EEG); (4) one or more pedometers; (5) one or more thermometers; (6) one or more transdermal sensors; (7) one or more front-facing cameras; (8) one or more eye-facing cameras; (9) one or more microphones; (10) one or more accelerometers; (11) one or more blood pressure sensors; (12) one or more pulse oximeters; (13) one or more respiratory rate sensors; (14) one or more blood alcohol concentration (BAC) sensors; (15) one or more near-field communication sensors; (16) one or more motion sensors; (17) one or more gyroscopes; (18) one or more geomagnetic sensors; (19) one or more global positioning system (GPS) sensors; (20) one or more impact sensors; (21) one or more wireless communication sensors (e.g., a Bluetooth chip); (22) one or more tear sensors; (23) one or more olfactory sensors; and/or (24) any other suitable one or more sensors. In particular embodiments, the one or more sensors comprise a pulse oximeter, a front-facing camera, an eye-facing camera, an accelerometer and a gyroscope.

In particular embodiments, the one or more sensors 130 are configured to gather data, for example, about the wearer such as the wearer's heart rate, heart electrical activity, brain electrical activity, transdermal activity, tear composition, blood pressure, blood oxygen level, respiratory rate, perspiration level, or blood alcohol concentration, and transmit a signal representative of the data to the at least one processor 132. In various embodiments, the one or more sensors 130 are configured to gather data about the distance traveled by the wearer, the steps taken by the wearer, the acceleration of the wearer, and/or an impact sustained by the wearer. The one or more sensors 130, in particular embodiments, may also be configured to gather data such as one or more images, one or more sounds, one or more near-field communications, one or more motions, and/or one or more GPS locations. In various embodiments, the one or more sensors 130 are configured to, for example, store the gathered data and transmit the data (e.g., a signal representative of the data) to the at least one processor, which may analyze the data and determine information based on the gathered data. The information may be: (1) provided to one or more medical professionals, for example, to aid in the diagnosis and/or treatment of the wearer; (2) used to predict one or more medical issues associated with the wearer (e.g., the illness or death of the user); and/or (3) used by a third party to take any other suitable action based at least in part on the information.

In particular embodiments, the system is configured to receive input from a user (e.g., a wearer of the eyewear) via one or more gestures, for example, using at least one of the sensors described immediately above. In various embodiments, the system may, for example, be configured to: (1) identify a gesture performed by the user; and (2) at least partially in response to identifying the gesture, perform a function associated with the gesture. In particular embodiments, the system may be configured to perform a particular function in response to identifying a particular gesture, where the particular gesture is associated with the particular function. In particular embodiments, the system may be configured to enable the user to provide one or more gestures for performing a particular function. In such embodiments, the system may, for example: (1) receive a selection of a particular function from the user; (2) receive input of one or more gestures from the user; and (3) associate the particular function with the one or more gestures.

In various embodiments, the one or more gestures may include, for example: (1) one or more hand gestures (e.g., a thumbs up, a wave, two thumbs up, holding up any particular number of fingers, making one or more fists, performing a particular movement with one or more hands, etc.); (2) one or more head movements (e.g., shaking of the user's head, a nod, etc.); (3) one or more eye movements (e.g., looking in a particular direction for a particular period of time, a wink, blinking, blinking in a particular pattern, etc.); (4) one or more facial movements (e.g., a smile, a frown, sticking out of a tongue, etc.); and/or (5) any suitable combination of these or any other suitable gestures.

In particular embodiments, the system is configured to identify the one or more gestures, for example, using a suitable imaging device (e.g., a camera) that is part of the system. In particular embodiments, the imaging device may be directed toward an area in front of the user while the user is wearing the eyewear 100 and configured to identify gestures performed by the user's hands, arms, feet, legs, etc. In other embodiments, the system may include an imaging device directed toward the user's face and/or eyes while the user is wearing the eyewear 100 that is configured to identify gestures performed by the user's face and/or eyes. In other embodiments, the system comprises one or more gyroscopes and/or accelerometers configured to determine a position or change in position of the eyewear 100 while the user is wearing the eyewear. In such embodiments, the one or more gyroscopes and/or accelerometers are configured to identify one or more gestures performed by the user that include one or more gestures that include movement of the user's head. In still other embodiments, the system comprises one or more gyroscopes and/or one or more accelerometers disposed on any other portion of the user's body configured to identify any gesture performed by the user using the other portion of the user's body (e.g., arm, hand, leg, foot, etc.). In various embodiments, the system comprises any other suitable sensor for identifying one or more gestures performed by the user.

Second Temple

In various embodiments, the second temple 114 substantially mirrors the shape of the computerized temple 102. Thus, for purposes of ease of understanding and clarity, only certain parts will be discussed to highlight the differences in the structure and operation of the embodiment shown in FIGS. 1-2. As shown in FIG. 1, the second temple 114 is adjacent the frame second end 116 and substantially parallel to the computerized temple 102. The second temple 114 extends substantially rearward from the eyewear frame 108 adjacent the frame second end 116. As shown in FIG. 2, similar to the computerized temple 102, the second temple 114 includes a first end 114a and a second end 114b. An earpiece 208 is proximate the second end 114b. A second temple hinge connection 206 is proximate the first end 114a.

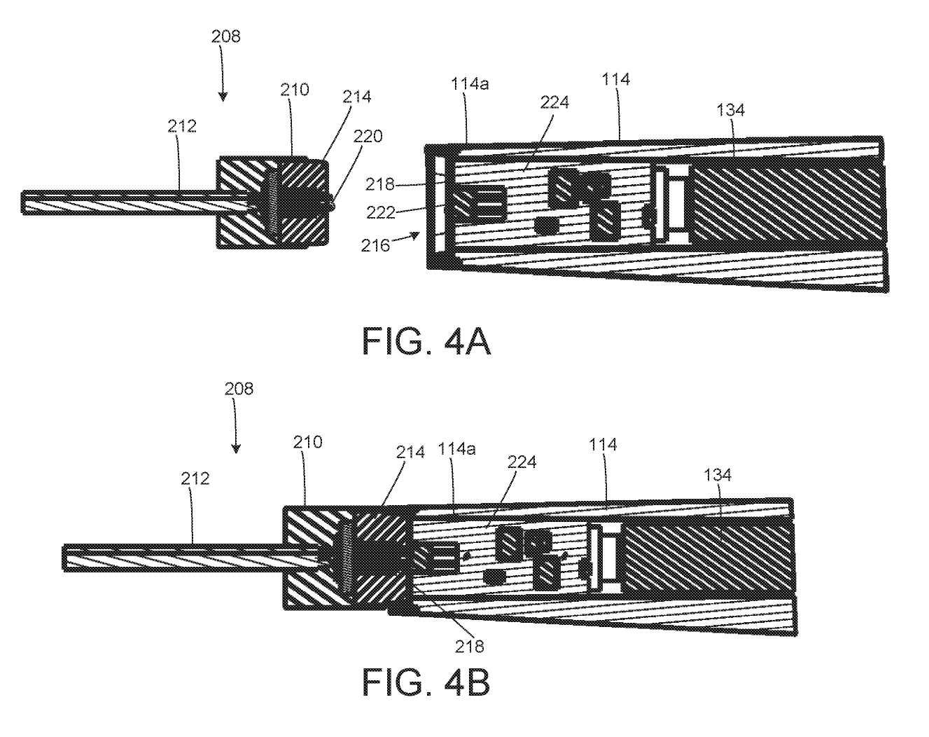

The second temple hinge connection 206 is adapted to be releasably coupled to the eyewear frame second connection receiving end 128 by any suitable second hinge connection 204 (e.g., ball and socket hinge connection, friction fit hinge, screw hinge, spring loaded ball and catch hinge, spring loaded pin and catch hinge, or spring tab and catch hinge). Thus, the second temple 114 is releasably coupled to the eyewear frame 108 at the eyewear frame second end 116 by the coupling of the second hinge connection receiving end 128 to the second temple hinge connection 206 (FIG. 4A) at the second hinge connection 204. Similar to the computerized temple 102, for each of the different hinge connections, the second hinge connection receiving end 128 and the second temple hinge connection 206 are formed by complimentary hinge connections 204. For instance, where the second hinge connection receiving end 128 is a screw hinge, the second temple hinge connection 206 may also be a screw hinge. It should be understood that the computerized temple may replace the first temple 102 or the second temple 114.

Recharging Port

In various embodiments and as described above, the computerized temple 102 contains a power source 134 (FIG. 1). In some embodiments, the power source 134 comprises at least a rechargeable battery such as a rechargeable alkaline battery, a nickel metal hydride (NiMH) battery, a lithium ion (Li-ion) battery, a lithium ion polymer (Li-ion polymer) battery, a nickel cadmium (NiCd) battery, a Nickel zinc battery, a Nickel-Iron battery, or any other suitable rechargeable type battery. In various embodiments, the power source 134 may comprise multiple rechargeable batteries.

Referring to FIGS. 3A-3B, the computerized eyewear is shown having the second temple 114 as the computerized temple. In various embodiments, the power source may be recharged by connecting a recharging cable 208 into a charging port 216 of the second temple 114. The charging port 216 is partially formed by a recessed socket 217 that is configured to receive a male portion 214 of a charging cable connector 210. The charging cable connector 210 is coupled to a cord 212 that has a second end that is plugged into an external power source. In various embodiments, the charging port 216 may take the form of various female connectors such as a micro universal serial bus (USB) female socket, a mini USB female socket, a LIGHTENING® socket, or any other suitable charging configuration.

In particular embodiments, the charging port recess 217 contains a plate 218 formed from a magnetic, ferromagnetic or paramagnetic material. In embodiments where a magnetic or paramagnetic material is used for the plate 218, the charging connector male portion 214 may be formed from a magnetic material. In this way and referring to FIG. 3B, when the charging cable connector 210 comes into close proximity to the charging recess 217, the magnetic male portion 214 is attracted to the plate 218 so that the charging connector 210 engages with and stays coupled to the charging port 216 until a sufficient force is applied to separate the charging connector 210 from the charging port 216.

In various embodiments, the plate 218 may be made from a polymer material that forms a front wall of a chamber that is located in the charging port recess 217. A rear wall (not shown) is spaced apart from the sidewall thereby defining a chamber therebetween. The chamber (not shown) can be filled with a paramagnetic fluid. Thus, when the fluid is in the presence of the magnetic force from the magnet on the charging cable connector 210, the paramagnetic fluid exhibits magnetic properties that assist in retaining the charging cable connector 210 in the charging port recess 217.

In various embodiments, use of a paramagnetic material is beneficial since it only exhibits magnetic properties when it is in the presence of a magnetic field (e.g., the magnetic field from male portion 214). Therefore, if the computerized temple contains sensitive magnetic sensors, the paramagnetic material in the charging port 216 will not interfere with the operation of the various sensors since the paramagnetic material loses its magnetism as soon as the magnetic male portion 214 is removed. In various embodiments, the plate 218 may also be formed from a material that turns magnetic when coupled to an electrical source (e.g., an electromagnetic material). In these embodiments, the plate 218 becomes magnetic when the charging cable is couple to the charging port 216 as electricity is passed through the plate 218.

Referring to FIGS. 4A-4B, the charging cable male portion 214 may surround one or more electrical contacts 220 that are configured to engage with one or more metal electrical contacts 222 located in the charging port 216 through the plate 218. The one or more electrical contacts 222 are operatively coupled to a circuit board 224 that is operatively coupled to the rechargeable power source 134. The circuit board 224 may contain one or more electrical components that regulate and control the charging of the rechargeable power source 134.

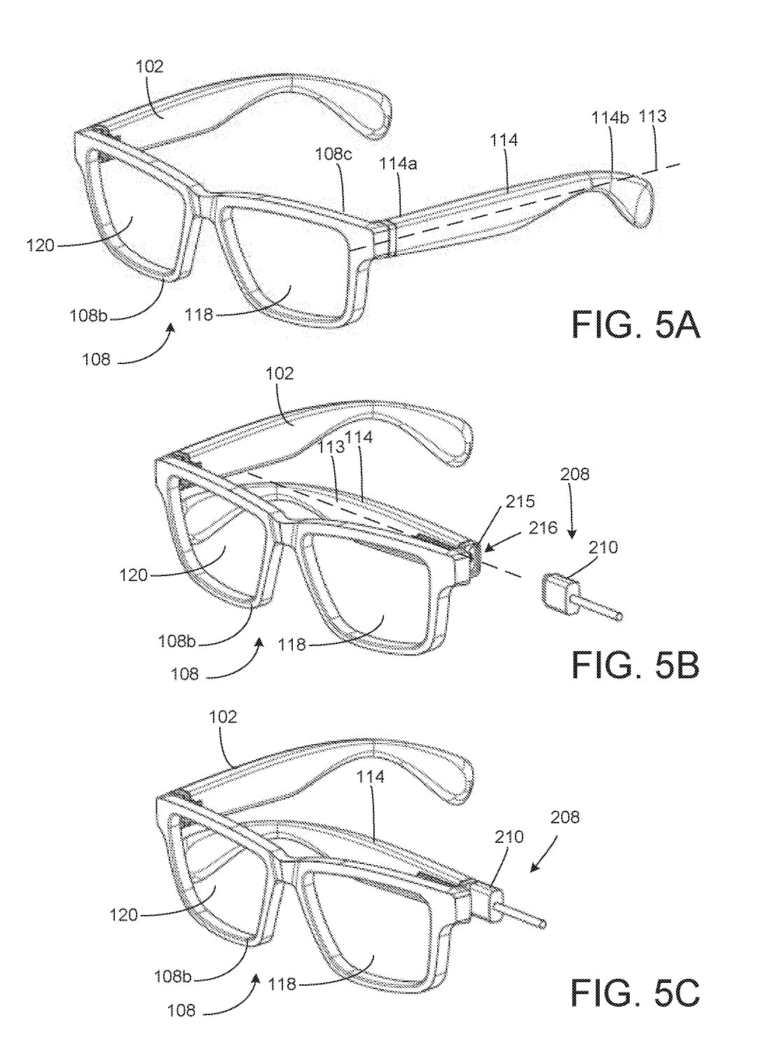

Referring to FIGS. 5A-5C, the computerized eyewear is shown where the second temple 114 is the computerized temple. In various embodiments, the charging port 216 is formed in a first end 114a of the second temple 114 through a first end surface 215. Thus, when a longitudinal axis 113 of the second temple 114 is positioned substantially perpendicular (e.g., perpendicular) to a rear surface 108c of the frame 108, the charging port 216 is hidden from view since the first end surface 215 abuts the rear surface 108c of the frame. Moreover, referring to FIG. 5B, when the longitudinal axis 113 of the second temple 114 is positioned substantially parallel (e.g. parallel) to the rear surface 108c of the frame 108, the charging port is accessible to allow the user to couple the charging connector 210 to the charging port 216, as shown in FIG. 5C.

### Exemplary Computing Device Architecture

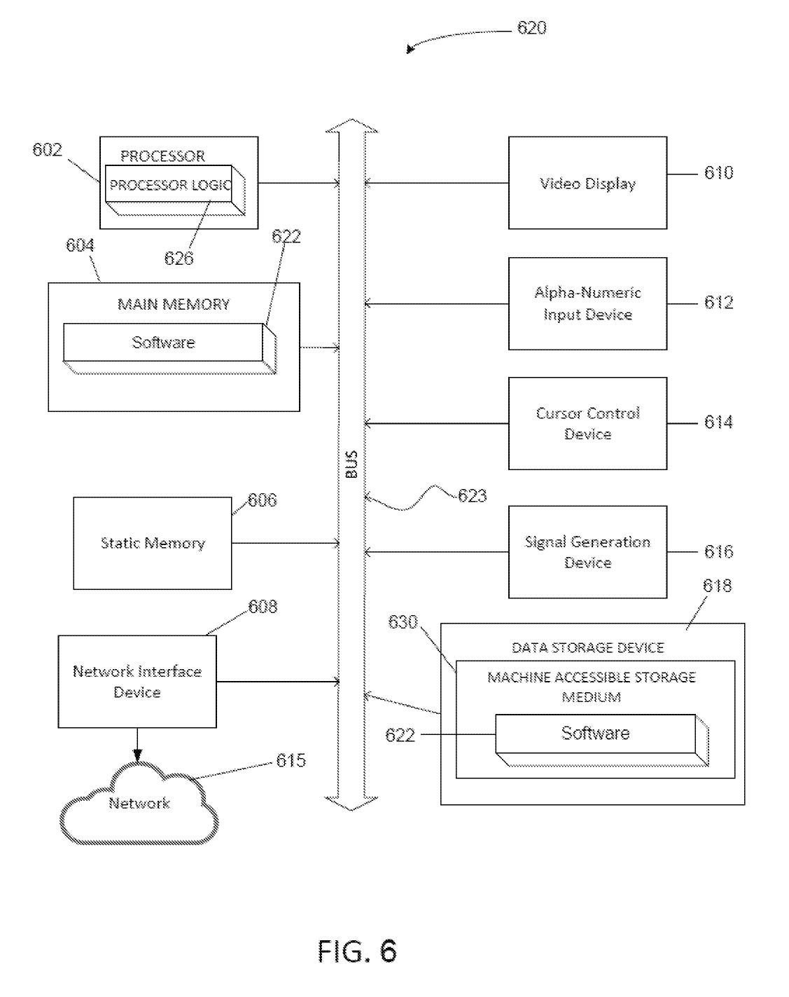

FIG. 6 illustrates a diagrammatic representation of a computer architecture 620 that can be used within a computerized temple (e.g., computerized temple 102 of FIG. 1) as the at least one processor 132. In particular embodiments, the computing device 620 may be connected (e.g., networked) to other computing devices in a LAN, an intranet, an extranet, wirelessly (e.g., via WIFI), via Bluetooth, and/or the Internet. As noted above, the computing device 620 may operate in the capacity of a server or a client computing device in a client-server network environment, or as a peer computing device in a peer-to-peer (or distributed) network environment. Further, while only a single computing device is illustrated, the term “computing device” shall also be interpreted to include any collection of computing devices that individually or jointly execute a set (or multiple sets) of instructions to perform any one or more of the methodologies discussed herein.

An exemplary computer device 620 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 623.

The processing device 602 represents one or more general-purpose or specific processing devices such as a microprocessor, a central processing unit (CPU), or the like. More particularly, the processing device 602 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 may be configured to execute processing logic 626 for performing various operations and steps discussed herein.

The computing device 620 may further include a network interface device 608. The computing device 620 may also include a video display unit 610 (e.g., a liquid crystal display (LCD) or a cathode ray tube (CRT)), an alpha-numeric input device 612 (e.g., a keyboard), a cursor control device 614 (e.g., a mouse), and a signal generation device 616 (e.g., a speaker).

The data storage device 618 may include a non-transitory computing device-accessible storage medium 630 (also known as a non-transitory computing device-readable storage medium, a non-transitory computing device-readable medium, or a non-transitory computer-readable medium) on which is stored one or more sets of instructions (e.g., software 622) embodying any one or more of the methodologies or functions described herein. The one or more sets of instructions may also reside, completely or at least partially, within the main memory 604 and/or within the processing device 602 during execution thereof by the computing device 620—the main memory 604 and the processing device 602 also constituting computing device-accessible storage media. The one or more sets of instructions may further be transmitted or received over a network 615 via a network interface device 608.

While the computing device-accessible storage medium 630 is shown in an exemplary embodiment to be a single medium, the term “computing device-accessible storage medium” should be understood to include a single medium or multiple media (e.g., a centralized or distributed database, and/or associated caches and servers) that store the one or more sets of instructions. The term “computing device-accessible storage medium” should also be understood to include any medium that is capable of storing, encoding, or carrying a set of instructions for execution by the computing device and that causes the computing device to include any one or more of the methodologies of the present invention. The term “computing device-accessible storage medium” should accordingly be understood to include, but not be limited to, solid-state memories, optical and magnetic media, etc.

### Conclusion

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. For example, the computerized eyewear temple described in these embodiments may include any other suitable eyewear temple for eyewear, such as, for example, ski or swim goggles, sunglasses, safety goggles or glasses, etc. Therefore, it is to be understood that the invention is not to be limited to the specific embodiments disclosed herein, and that the modifications and other embodiments are intended to be included within the scope of the appended exemplary concepts. Although specific terms are employed herein, they are used in a generic and descriptive sense only and not for the purposes of limitation.

What is claimed is:

1. Computerized eyewear comprising:
a. a frame having a first end, a second end, a top surface, a front surface and a rear surface;
b. a first temple comprising:
i. a first end having a surface, wherein the first temple first end is pivotally coupled to the frame first end; and
ii. a second end configured to rest on an ear of a wearer of the computerized eyewear;
c. a second temple comprising:
i. a first end that is pivotally coupled to the frame second end; and
ii. a second end configured to rest on another ear of the wearer of the computerized eyewear;
d. at least one processor coupled to one of the first temple or the frame;
e. a power source coupled to one of the first temple or the frame, wherein the at least one processor is operatively coupled to the power source; and
f. a charging socket positioned in the first temple, first end surface, wherein the charging socket is operatively couple to the power source,
wherein the charging socket is hidden from view when the first temple is positioned substantially perpendicular to the frame rear surface.

2. The computerized eyewear of claim 1, wherein the charging socket is a micro universal serial bus female socket.

3. The computerized eyewear of claim 1, wherein the charging socket further comprises a magnetic material that is configured to retain a charging connector in the charging socket.

4. The computerized eyewear of claim 3, wherein the magnetic material is a paramagnetic material that possesses magnetization in the presence of a magnetic field.

5. The computerized eyewear of claim 1, wherein when the temple is positioned substantially parallel to the frame rear surface, the charging socket is accessible to allow the wearer to insert a charging cable into the charging socket.

6. The computerized eyewear of claim 4, further comprising a charging cable that comprises a magnetic tip.

7. Computerized eyewear comprising:
a. a frame having a first side, a second side, an upper surface and a lower surface;
b. at least one temple comprising a first end configured to be coupled to the first side of the frame, a second end configured to rest on an ear of a wearer, and a longitudinal axis that extends from the first end to the second end;
c. a processor coupled to one of the frame or the at least one temple;
d. a rechargeable power source coupled to one of the frame or the at least one temple and operatively coupled to the processor; and
e. a charging port positioned on the first end of the at least one temple,
wherein the charging port is configured to releasably receive a charging cable connector so that the rechargeable power source can be recharged when the charging cable is connected to the charging port.

8. The computerized eyewear of claim 7, wherein the at least one temple first end is pivotally coupled to the frame first side so that when the at least one temple longitudinal axis is positioned perpendicular to a plane that extends between the frame first side and the frame second side, the charging port is hidden from view.

9. The computerized eyewear of claim 7, wherein the charging port is a socket selected from a group consisting of:
a. a micro universal serial bus female socket;
b. a mini universal serial bus female socket; and
c. a Lightning® female socket.

10. The computerized eyewear of claim 7, wherein the charging port further comprises a magnetic material that retains the charging cable in the charging port.

11. The computerized eyewear of claim 10, wherein the magnetic material is a plate that is mounted in the charging port.

12. The computerized eyewear of claim 10, wherein the magnetic material is a paramagnetic material.

13. A computerized temple retrofit kit for use with an eyewear frame, the computerized temple comprising:
a. an elongated body having:
i. a first end comprising a first end surface and a connector that is configured to pivotally couple to an eyewear frame; and
ii. a second end configured to rest on an ear of a wearer wearing the eyewear frame;
b. at least one processor mounted in the elongated body;
c. a rechargeable power source mounted in the elongated body and operatively coupled to the at least one power source;
d. at least one sensor coupled to the elongated body and operatively coupled to the at least one processor; and
e. a charging port formed in the elongated body first end surface that is configured to receive a charging cable,
wherein when the computerized temple is coupled to an eyewear frame using the connector:
the elongated body is substantially perpendicular to a rear surface of the eyewear frame, the charging port is hidden, and
the elongated body is substantially parallel to the rear surface of the eyewear frame, the charging port is accessible so that the wearer can connect the charging cable to the charging port to recharge the rechargeable power source.

14. The computerized temple retrofit kit of claim 13, wherein the charging port is a micro universal serial bus female socket.

15. The computerized temple retrofit kit of claim 13, wherein the charging port further comprises a magnetic material that is configured to retain a charging connector of the charging cable in the charging port.

16. The computerized temple retrofit kit of claim 15, wherein the magnetic material is a paramagnetic material that possesses magnetization in the presence of a magnetic field.

17. The computerized temple retrofit kit of claim 16, further comprising a charging cable that comprises a magnetic tip.

18. The computerized temple retrofit kit of claim 13, further comprising instructions explaining how to pivotally couple the computerized temple to a standard eyewear frame.

19. The computerized temple retrofit kit of claim 15, wherein the magnetic material is an electromagnetic material that becomes magnetized when an electric current is passed through the material.
